(19) United States
(12) Patent Application Publication
(10) Pub. No.: US 2025/0373192 A1
(43) Pub. Date: Dec. 4, 2025

(54) APPARATUS, SYSTEM, AND METHODS FOR SOLAR MOUNTING CLAMP AND/OR MOUNTING HOOK IN SOLAR RACKING SYSTEMS

(71) Applicant: Paul W. Budge, St. George, UT (US)

(72) Inventor: Paul W. Budge, St. George, UT (US)

(21) Appl. No.: 19/226,012

(22) Filed: Jun. 2, 2025

Related U.S. Application Data
(60) Provisional application No. 63/731,691, filed on May 31, 2024.

(51) Int. Cl. H02S 20/23

(52) U.S. Cl. CPC H02S 20/23

(57) ABSTRACT

An apparatus, system, and method of mounting a solar panel using a mounting clamp are described herein. A mounting clamp for mounting a structural member to a solar panel, the mounting clamp includes a body, at least one receiving slot in the body for receiving a flange of a solar panel, and a fastener attached to the body for connecting the mounting clamp, the solar panel, and the structural member. A system includes a structural member having at least one vertical component, at least one solar panel, and at least one mounting clamp for mounting the structural member to a solar panel. The mounting clamp includes a body, at least one receiving slot in the body for receiving a flange of a solar panel, and a fastener attached to the body for connecting the mounting clamp, the solar panel, and the structural member.

### CROSS-REFERENCES TO RELATED APPLICATIONS

This application claims the benefit of U.S. Provisional Patent Application No. 63/731,691 entitled “SOLAR MODULE FLANGE CLAMP MOUNT AND FLANGE HOOK SOLAR MODULE RACKING SYSTEM” and filed on May 31, 2024, for Paul W. Budge, which is incorporated herein by reference. This application incorporates herein by reference patent application Ser. No. 19/172,552 entitled “APPARATUS, SYSTEM, AND METHODS FOR MODULAR SOLAR RACKING SYSTEM” and filed on Apr. 7, 2024, for Paul W. Budge.

### FIELD

This disclosure relates generally to systems for mounting solar modules, and in particular, mounting clamps and hooks for mounting solar modules on a variety of frames or surfaces.

### BACKGROUND

As solar energy becomes more popular, so do new ways to secure solar panels to different structures, such as racking frames and mounting brackets. Over time, these systems have been improved to make them easier and faster to install. However, some challenges remain, especially when setting up or installing a solar panel system. For example, many current systems are made up of numerous costly components, which can make installation expensive. Many solar panel systems require the use of large or costly under mount horizontal rails for the mounting the solar panel to a frame, or other similar structure.

Solar panels are used to create electricity for homes and businesses. Since one panel can only produce a small amount of electricity, several panels are usually grouped together to form a system. Even though there are many systems available to secure solar panels, they often have significant downsides. Some systems are expensive to make or take a long time to install. Others might require custom parts to fit specific types of panels, which makes the process more complicated.

Because of these challenges, there's still a lot of room to create better mounting systems for solar panels—systems that are more affordable, easier to install, more cost-effective, and eco-friendly.

### SUMMARY

A mounting clamp for mounting a structural member to a solar panel, the mounting clamp includes a body, at least one receiving slot in the body for receiving a flange of a solar panel, and a fastener attached to the body for connecting the mounting clamp, the solar panel, and the structural member.

In some examples, the mounting clamp has a body that is u-shaped. In some examples, the u-shaped body further includes at least one barb that is at least partially formed by the at least one receiving slot, the at least one barb configured to contact a vertical component of the solar panel to at least partially secure the clamp fastener to the solar panel. In some examples, the upper portion of the slot comprises the at least one barb and a lower portion of the slot extends beyond the length of the at least one barb of the upper portion of the slot.

In some examples, the mounting clamp fastener includes a bolt protruding lengthwise through at least part of the body.

In some examples, the mounting clamp body includes threads for receiving a threaded fastener.

In some examples, the flange of the solar panel is a lower return flange of the solar panel.

In some examples, the mounting clamp fastener sandwiches the solar panel flange between the mounting clamp and the structural member.

A system includes a structural member having at least one vertical component, at least one solar panel, and at least one mounting clamp for mounting the structural member to a solar panel. The mounting clamp includes a body, at least one receiving slot in the body for receiving a flange of a solar panel, and a fastener attached to the body for connecting the mounting clamp, the solar panel, and the structural member.

In some examples, the system includes a mounting clamp having a u-shaped body. In some examples, the u-shaped body further includes at least one barb that is at least partially formed by the at least one receiving slot, the at least one barb configured to contact a vertical component of the solar panel to at least partially secure the clamp fastener to the solar panel. In some examples, the upper portion of the slot comprises the at least one barb and a lower portion of the slot extends beyond the length of the at least one barb of the upper portion of the slot.

In some examples, the mounting clamp fastener includes a bolt protruding lengthwise through at least part of the mounting clamp body and extends at least partially through at least one vertical component of the structural member.

In some examples, the mounting clamp body includes threads for receiving a threaded fastener.

In some examples, the flange of the solar panel is a lower return flange of the solar panel.

In some examples, the mounting clamp fastener sandwiches the solar panel flange between the mounting clamp and the structural member.

In some examples, the structural member is a standoff bracket comprising at least one vertical member and at least one horizontal member for securing the system to an external surface.

In some examples, the structural member is a rack frame including at least one vertical leg for receiving the fastener of the mounting clamp.

In some examples, the at least one solar panel is secured by the mounting clamp to the structural member at a height which permits airflow beneath the at least one solar panel.

A method of securing a structural component to a structural member by receiving a flange of a solar panel in a receiving slot of a body of a mounting clamp, wherein the mounting clamp includes the body, the at least one receiving slot in the body for receiving the flange of the solar panel, and a fastener attached to the body for connecting the mounting clamp, the solar panel, and the structural member. Aligning the solar panel to the structural member. Securing the fastener of the mounting clamp to the structural member. Tightening the fastener of the mounting clamp until the solar panel is abutted to the structural member.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of a mounting clamp, according to one or more examples disclosed herein;

FIG. 2 is a top view of the mounting clamp of FIG. 1, according to one or more examples disclosed herein;

FIG. 3 is a side view of the mounting clamp of FIG. 1, according to one or more examples disclosed herein;

FIG. 4 is an exploded view of the mounting clamp of FIG. 1, according to one or more examples disclosed herein;

FIG. 5 is an exploded view of a mounting clamp, according to one or more examples disclosed herein;

FIG. 6 is an exploded view of a mounting clamp, according to one or more examples disclosed herein;

FIG. 7 is a system of securing a mounting clamp to a structural member, according to one or more examples disclosed herein;

FIG. 8 is a system of securing a solar panel to a structural member using a mounting clamp, according to one or more examples disclosed herein;

FIG. 9 is a system of securing a solar panel to a structural member using a mounting clamp, according to one or more examples disclosed herein;

FIG. 10 is a partially exploded view of a system of securing a solar panel to a structural member using a mounting clamp, according to one or more examples disclosed herein;

FIG. 11 is a partially exploded view of a system of securing a solar panel to a structural member using a mounting clamp, according to one or more examples disclosed herein;

FIG. 12 is an exploded view of a system of securing a solar panel to a structural member using a mounting clamp, according to one or more examples disclosed herein;

FIG. 13 is the system of FIG. 12, according to one or more examples disclosed herein;

FIG. 14 is a system of securing a solar panel to a structural member using a mounting clamp, according to one or more examples disclosed herein;

FIG. 15 is a system of securing multiple solar panels to a structural member using mounting clamps, according to one or more examples disclosed herein;

FIG. 16 is a system of securing a solar panel to a structural member using a mounting clamp and a mounting hook, according to one or more examples disclosed herein;

FIG. 17 is a system of securing multiple solar panels to a structural member using a mounting clamp and a mounting hook, according to one or more examples disclosed herein;

FIG. 18 is a system of securing multiple solar panels to a structural member using mounting hooks, according to one or more examples disclosed herein; and

FIG. 19 is a mounting clamp, according to one or more examples disclosed herein.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Furthermore, the described features, structures, or characteristics of the invention may be combined in any suitable manner in one or more examples. In the following description, numerous specific details are provided, such as examples of mounting structures, adjustment mechanisms, materials, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The description of elements in each figure may refer to elements of proceeding figures. Like numbers refer to like elements in all figures, including alternate embodiments of like elements.

Typically, most solar modules are mounted to roof racks and ground mounted solar rack frames with two under the solar module mounting rails that the solar modules rest on before being clamped with end clamps and mid clamps from the top side of the solar modules to the horizontal rials running directly under the solar modules. One problem with this type of traditional mounting is that long expensive rials are required to be mounted to the upright roof brackets prior to the solar modules being mounted and clamped to these rails. Traditional mounting systems also need to be at a height higher than the roof than rail-less solar module racking systems in order to allow for airflow and wire management under the rails. Traditional mounting systems also have mounting clamps which are exposed on the top of the solar panel module.

Both the flange mounting clamp and the flange hook overcome the need for use of under mounting rails by relocating the top mount clamps. By utilizing the mounting clamp or mounting hook on the lower flange of a solar panel, the solar panel is mountable directly to a ground mount bracket or a racking frame without the need for horizontal racking rails. One advantage of these mounting types is that they allow for the use of simple inexpensive upright solar roof mounting brackets or an L-foot style upright bracket to be utilized as the mounting surface for the solar module and the mounting clamp, or mounting hook. Since the upright solar roof brackets are already in a vertical orientation, the brackets can easily be secured using the mounting clamp, or mounting hook, directly and in a compact, hidden configuration. When an installer has the ability to use a less expensive roof mounting system, as described herein, more roof brackets can be added to each solar module, as needed, to better distribute wind and snow loads. The system is mounted directly to roof surfaces, such as light gauge metal corrugated and asphalt covered wood sheeted type roofs, without the need to attach the upright solar roof brackets directly to a rafter or steel purlin underneath the metal roof skin or rafters under a sheet metal or asphalt shingle roof.

The system optionally electrically bonds or grounds itself with the sharp barbs protruding into the solar module frame and to the upright solar roof mounting bracket at the same time. When adding additional rows of solar modules, the upright solar roof brackets can be connected together, or overlapped, to form an electrical bond between solar module rows. The electrical grounding or bonding barbs can help electrically bond the system. The barb may further prevent the solar module frame from sliding out of position during the install process. The added friction element provided by the barb is critical when working on a slopped roof and trying to keep the solar module in position for the next row of upright solar roof brackets to be attached to the roof's surface.

Additionally, the solar module rows can be connected together on one side, or both sides, of the solar module's lower flange with a flange hook. The flange hooks could be attached with a fastener, or directly incorporated, into the upright solar roof bracket. Alternatively, the flange hook could be attached or directly incorporated into a mounting clamp. The flange hook can speed up the install process as no bolts are require to be attached to the solar module lower flange at all. A flange hook can be fastened to most all existing L-foot and other upright style solar roof bracket that incorporates an open center slot hole in the vertical face. The flange hook can be fastened directly to all upright solar roof brackets from most all solar industry manufactures, and the available open slot on most upright solar roof brackets currently being used today can be utilized to fasten to directly, and also work well with an anti-rotation catch to engage into this generic open slot area.

A solar module racking system includes a flange clamp mount, and optionally a flange hook, for attaching solar panels or solar modules directly to a roof structure or ground mounted frame structure. The system does not need a large or costly under mount horizontal rails. Rather, the mounting clamp and the mounting hook connect the vertical support structure directly to the solar panel by the lower flange located underneath the solar panel module. Described herein are a number of apparatus, systems, and methods for securing solar panels without the need for a horizontal rail.

In some examples, the apparatus is a mounting clamp having a body. In some examples, the body is a c-shaped metal body or solid casted body with a slot. The solar mounting clamp is compact and slides on and attaches directly to a bottom inner return flange of a solar module frame. The mounting clamp clamps directly to the solar panel and a support structure, such as a modular solar racking system or mounting bracket. In some examples, an upper portion of the slot could include at least one barb, or sharp pointed surface, to apply pressure to pierce the inner metal frame of a solar panel when the clamp mount is bolted to a mounting bracket or a solar frame. In some embodiments, the mounting clamp body includes a bolt hole.

In some examples, the solar mounting clamp receives a return flange in the receiving slot of the body of the mounting clamp. In some embodiments, the mounting clamp is configured to receive a portion of the solar flange withing the slot of the body. The solar flange is sandwiched within the slot to prevent unwanted rotation of the solar panel. In alternative embodiments, the mounting clamp in combination with a separate support member, such as a mounting bracket, structural rail, or structural frame member, sandwich a portion of the solar panel module, or frame, to prevent unwanted rotation of the solar panel.

In some examples, the mounting clamp can easily slide along the flange of the solar panel, or frame member, when the mounting clamp is not fully tightened or clamped down.

The mounting clamps can be used to mount micro inverters or solar optimizers to the solar module frame.

Also disclosed herein, is a flange hook which can attach or be incorporated into an upright solar roof bracket or to a mounting clamp. The flange hook can speed up the process of installing a system of solar modules as the flange hook does not require any bolts or fasteners to lock onto an inner flange of a solar module. The flange hook can be mounted or directly incorporated into both sides of a solar roof mounting bracket.

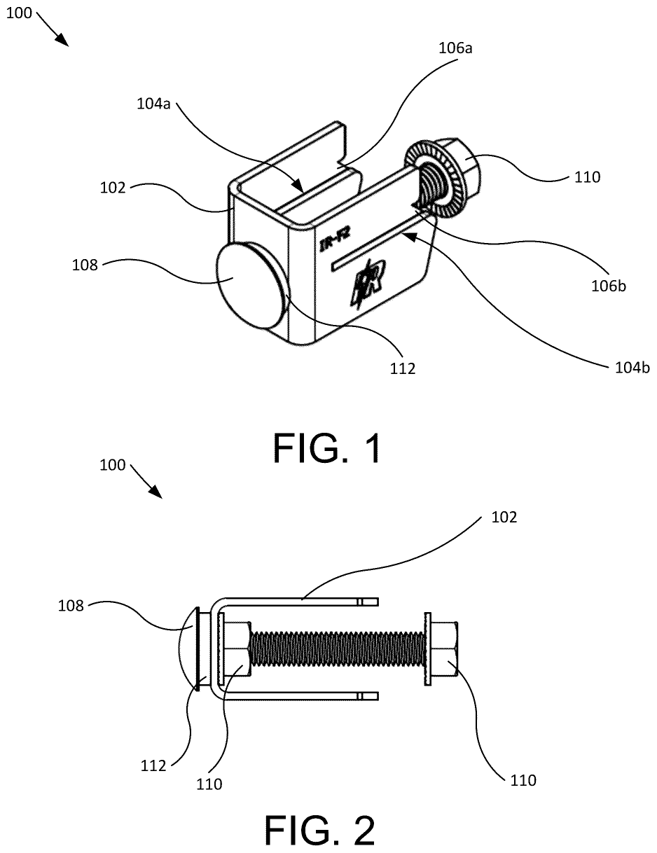

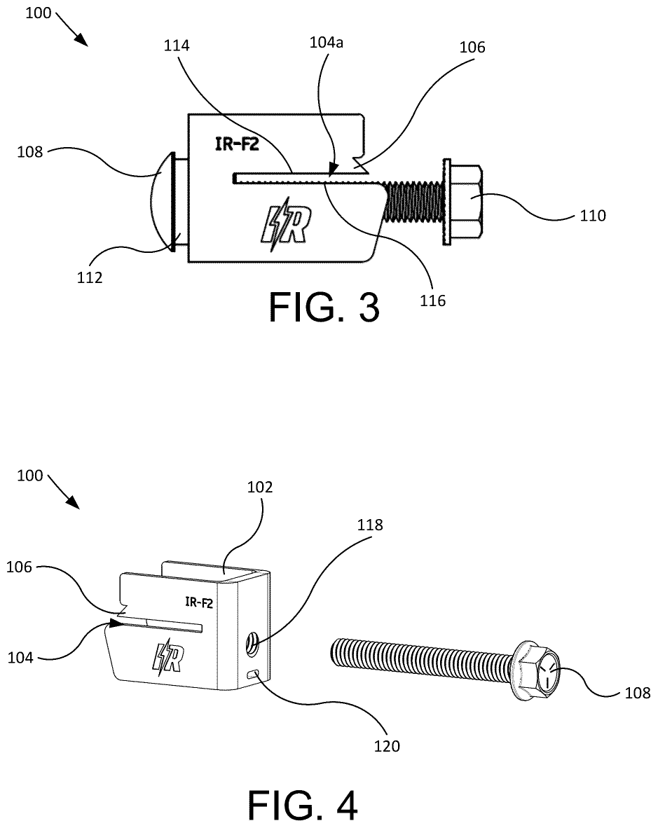

FIGS. 1-6 and 19 illustrate a mounting clamp 100 according to one or more examples disclosed herein. The mounting clamp 100 includes a body 102 having at least one slot 104 and a fastener. In some examples, the body 102 is a solid body and has a c-shaped. In some examples, as shown by FIGS. 1-6, the body 102 is u-shaped and may include two symmetrical slots 104a-b. In some examples, the body 102 comprises steel with a zinc plating. In alternative examples, the body 102 is stainless steel. In other examples, the body 102 is a metal composite.

In some examples, the at least one slot 104 is sized to receive a horizontal member of the solar panel 210. In some examples, the horizontal member is a lower flange 214. In some examples, the slot 104 has a height which is greater than the height of the lower flange 214. In other examples, the slot 104 has a height which is slightly less than the height of the lower flange 214 creating a tight or pressed fit. In some examples, the slot 104 has a depth equivalent to the depth of the lower flange 214. In some examples, the slot 104 of the mounting clamp 100 is configured to receive a portion of the solar flange 214. The solar flange 214 is sandwiched within the slot 104 to prevent unwanted rotation of the solar panel 210. In some examples, the mounting clamp 100 can easily slide along the flange 214 of the solar panel 210, or frame member of the solar panel, when the mounting clamp 210 is not fully tightened or clamped down. In some examples, as shown in FIGS. 1-6 and 19, the slot 104 creates an upper portion and a lower portion of the body 102. As illustrated, the lower portion of the body 102 extends beyond the length of the upper portion of the body 102. In some examples, the upper portion and lower portion of the body are symmetrical.

In some examples, the at least one slot 104 has an upper portion 114 and a lower portion 116, as illustrated in FIGS. 1-6. In some examples, as shown in FIGS. 1-6, the upper portion 114 of the slot 104 includes a sharp point, or barb 106, at the end of the slot 104. In some examples, the lower portion 116 extends beyond the length of the upper portion 114 of the slot 104. In some examples, the barb 106 has anodized point. In some examples, the barb 106 is configured to contact a vertical component 212 of the solar panel 210 to at least partially secure the mounting clamp to a solar panel 210. In some examples, the barb 106 is configured to pierce the vertical component 212 of the solar panel 210. In some examples, the barb 106 is a comprises a different material than the remainder of the body 102. In one example, the barb 106 is a more rigid material in order to pierce the vertical component 212 of the solar panel 210. In an alternate example, the barb 106 has more electrical conductivity properties than the body 102.

In some examples, the solar mounting clamp 100 may include a solid or flexible spring to pierce the anodized aluminum solar module frame 210 for electrical bonding to the solar module frame 210. The piercing point may catch and hold the solar module frame 210 to prevent it from sliding or pulling out easily during and after installation.

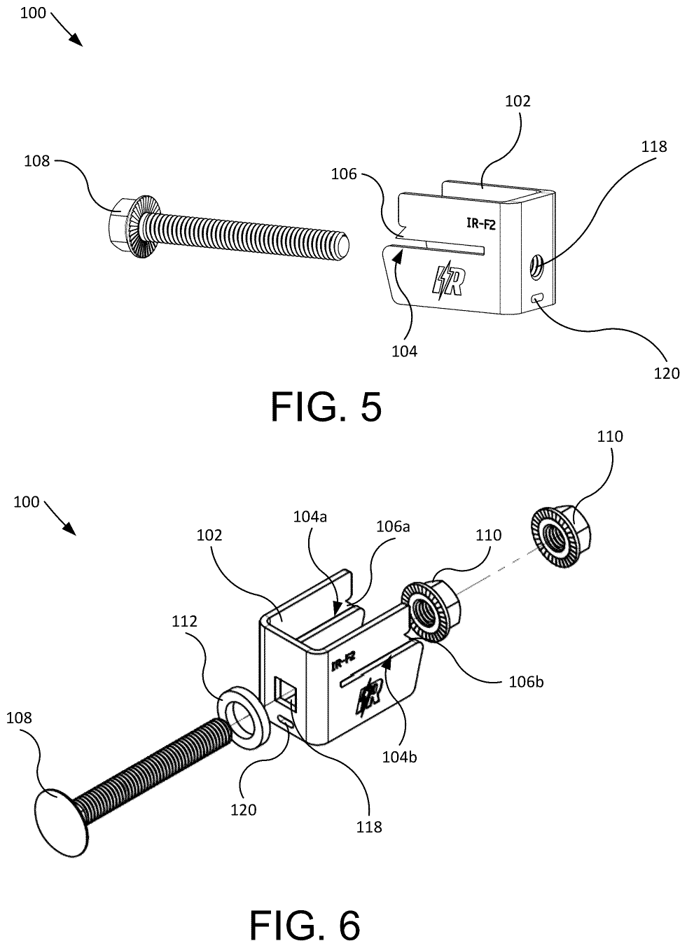

In some examples, the solar mounting clamp 100 includes a fastener. In some examples, the fastener includes a bolt 108 and at least one nut 110. In some examples, as shown by FIGS. 1-3 and 6, the bolt 108 is secured to the body 102 by a nut 110 and includes a second nut 110 at the end of the bolt 110 to secure and clamp the mounting clamp 100 to a system. In some examples, the mounting clamp 100 includes a washer 112 between the bolt head and the mounting clamp body 102. In other examples, the body 102 includes a threaded pass through 118 for the bolt 108. In some examples, the threaded pass through 118 of the body 102 is an integrated nut for a bolt, as shown in FIG. 5. In some examples, the bolt 108 protrudes lengthwise through at least part of the body 102. In some examples, the bolt 108 is parallel to the at least one slot 104.

In alternative example, the mounting clamp 100 is fastened to the structure using a press fit. The mounting clamp 100, in combination with a separate support member, such as a mounting bracket 202, structural rail, metal plate 204, or structural frame member 302, sandwich a portion of the solar panel module 210, or frame, to prevent unwanted rotation of the solar panel 210. In yet another example, the mounting clamp 100 is a singular body that is a press fit around a portion of the solar panel 210 and the body incorporates or directly attaches to a vertical portion of a mounting surface. The singular body incudes a receiving slot which is shaped to match the profile of the solar panel 210. In some examples, the receiving slot may include a relatively malleable layer which deforms as the mounting clamp is pressed into securement position.

In yet another example, the mounting clamp 100 uses a fastener system such as a cam and lever. In some examples, the fastener is rack and pinion or vise clamp. In other examples, the fastener is a spring clamp. A few examples of fasteners are described herein, however any fastener may be used in the design.

In some examples, the body 102 includes at least one aperture 120. In some examples, the at least one aperture 120 provides an opening for a zip tie or coupling mechanism that can be used to tie together a set of wires that may be present on the underside of a solar panel 210. In some examples, the at least one aperture 120 is a passthrough for wires that may be present on the underside of the solar panel 210.

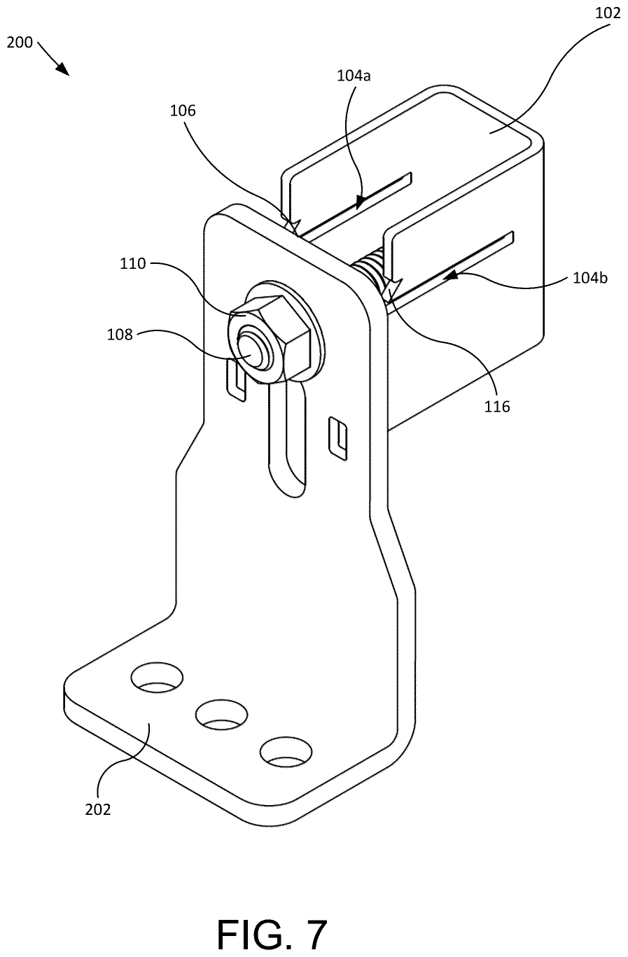

FIGS. 7-18 illustrate various exemplary systems of securing a solar panel 210 to a structural member, e.g. mounting bracket 202 or vertical member 302 of a racking frame. As shown in FIGS. 7-18, the solar panel 210 is secured on the under side of the solar panel 210. In addition to be being secured on the under side, the solar panel 210 is secured at a height which permits airflow beneath the solar panel 210. In some examples, the height is the upper height of the structural member. In other examples, the structural member may having a multitude of mounting points for varying installation heights for the solar panel 210.

FIGS. 7-13 illustrate exemplary systems of securing a solar panel to a structural member, such as a mounting bracket, using a mounting clamp, according to one or more examples disclosed herein. FIG. 7 illustrates a mounting clamp 100 and a L-shaped roof mounting bracket 202. In other examples, a mounting bracket 202 is u-shaped, having two vertical members and one horizontal member. In some examples, the mounting clamp 100 is secured to the vertical portion of the roof mounting bracket 202 by the fastener. FIG. 11 illustrates a system 200 which further includes a solar panel 210 sandwiched between the mounting bracket 202 and the mounting clamp 100.

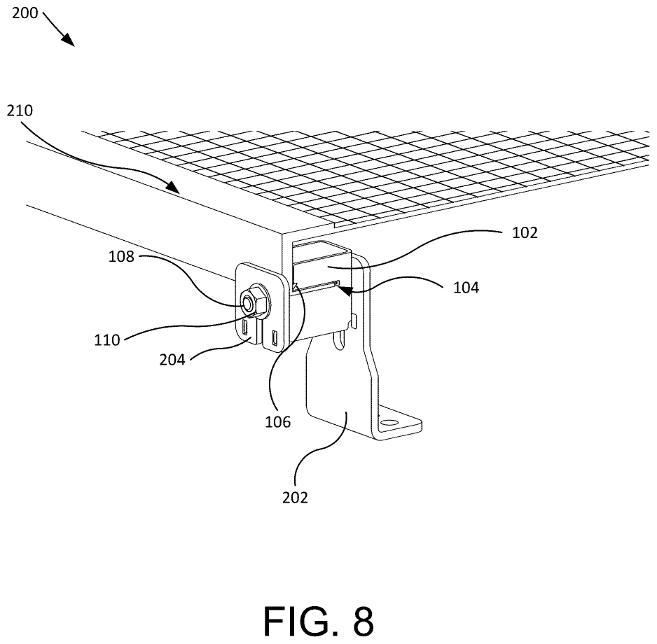

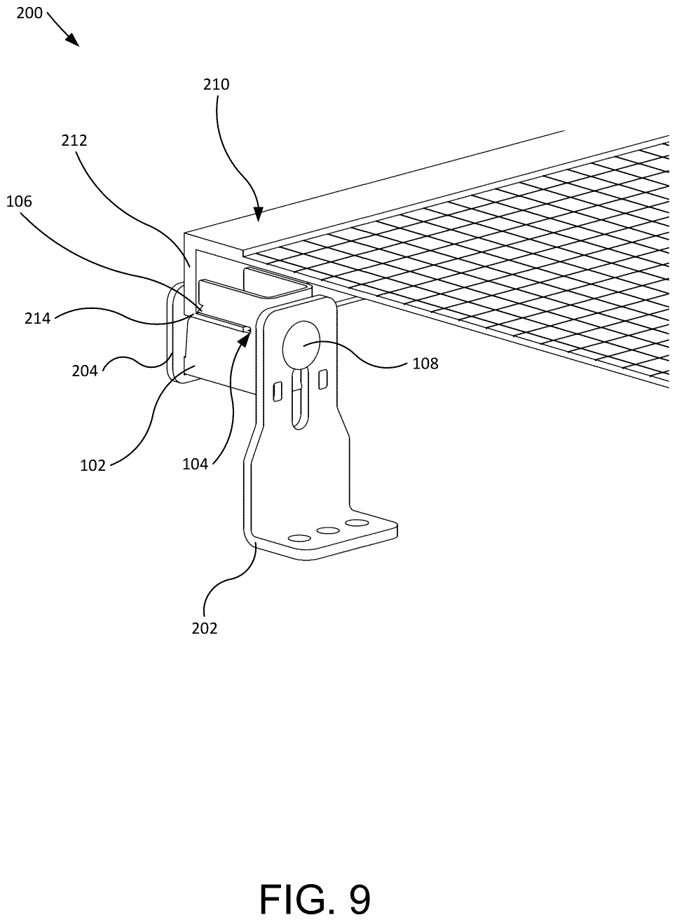

FIGS. 8-9 is an alternative exemplary system 200. As illustrated in FIGS. 8-9, the mounting clamp 100 is secured on one end to a mounting bracket 202. On the opposing side, a vertical plate 204 is attached to the fastener, bolt 108 and nut 110, for securing the solar panel 210 by the mounting clamp 100. In some examples, the body 102 of the mounting clamp 100 is co-manufactured with a mounting bracket 202 to form a singular body. In some examples, the lower portion of the body 102 of the mounting clamp 100 includes extrusions which correspond to one or more apertures in the vertical plate 204. As the mounting clamp fastener, e.g. bolt 108 and nut 110, is tightened, the extrusions fit within the apertures as a guide to prevent unwanted rotation of the vertical plate 204.

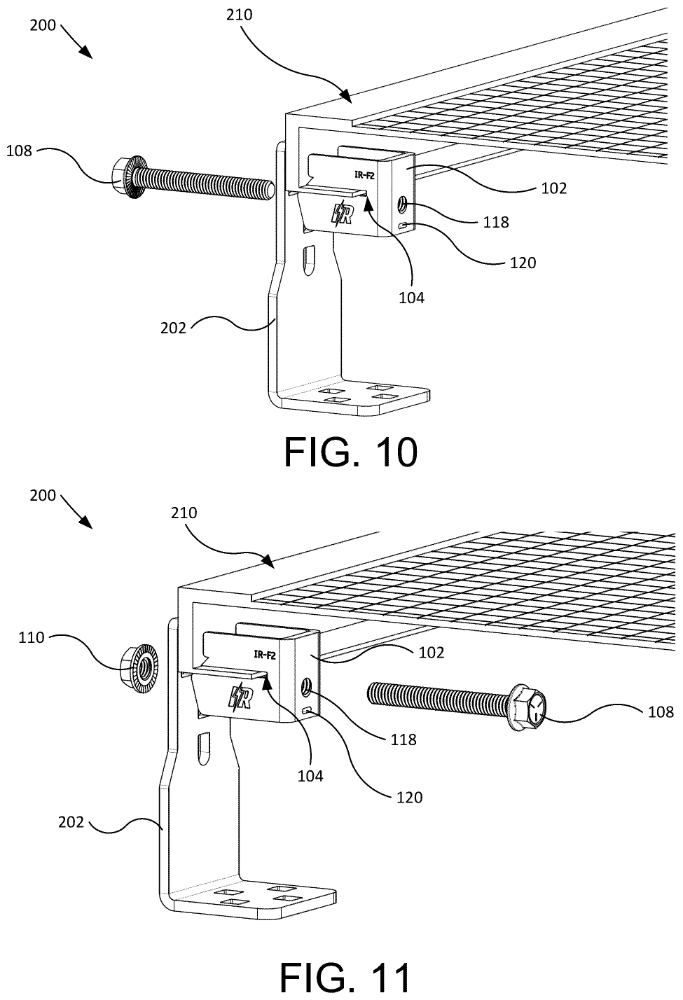

FIG. 10 illustrates an exemplary system 200 in which the mounting clamp 100 includes an integrated nut or threads 118 in the body 102 of the mounting clamp. As shown in FIG. 10, a fastener, bolt 108, is secured by the integrated threads 118 of the body 102. As the fastener is tightened, the solar panel 210 is sandwiched between the mounting clamp 100 and the mounting bracket 202.

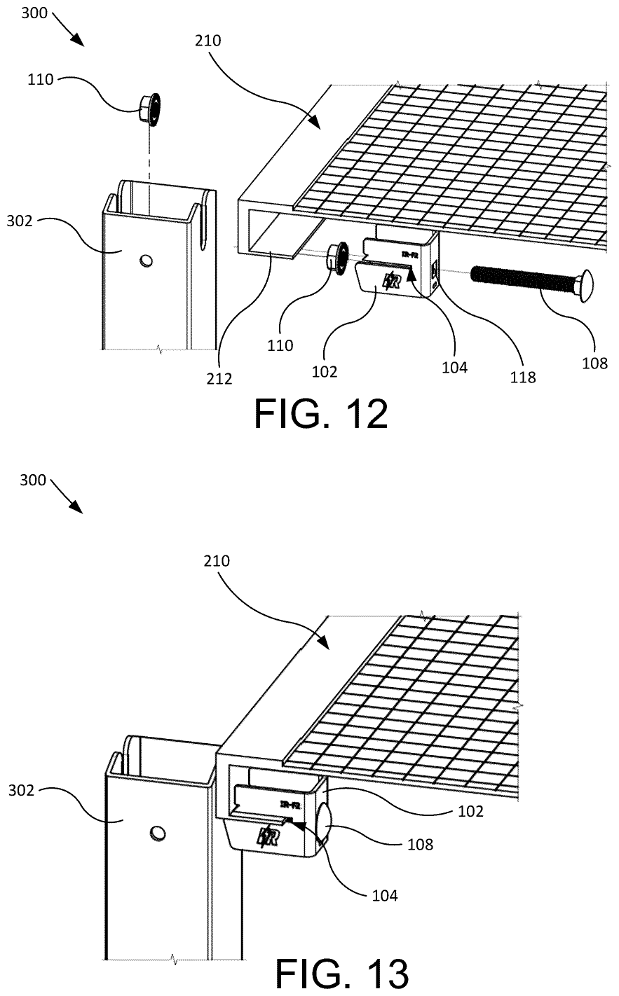

FIGS. 12-13 illustrate a system of securing a solar panel to a structural member using a mounting clamp. FIG. 12 is an exploded view of the system and illustrates one example of how to secure the mounting clamp 100 using a bolt 108 and nut 110 to fasten the mounting clamp 100 to the vertical member 302 of the racking frame. FIG. 13 is a secured system 300 of the mounting clamp 100, solar panel 210, and vertical member 302 of the racking frame. As shown, the mounting clamp 100 is directly attached to a vertical member 302 of a racking frame. The racking frame may be any racking frame which has at least one vertical leg. The frame and vertical member 302, shown in FIGS. 12-13, is further detailed in patent application Ser. No. 19/172,552 entitled “APPARATUS, SYSTEM, AND METHODS FOR MODULAR SOLAR RACKING SYSTEM” and filed on Apr. 7, 2024, for Paul W. Budge, which is incorporated herein by reference. In some examples, the racking frame is modular having at least two vertical members 302. Each of the vertical members 302 includes at least one upper aperture through which a clamp fastener can be secured to the vertical member 302. In some examples, the vertical member 302 permits one or more solar panels 210 to be mounted directly to vertical member 302 by a mounting clamp 100.

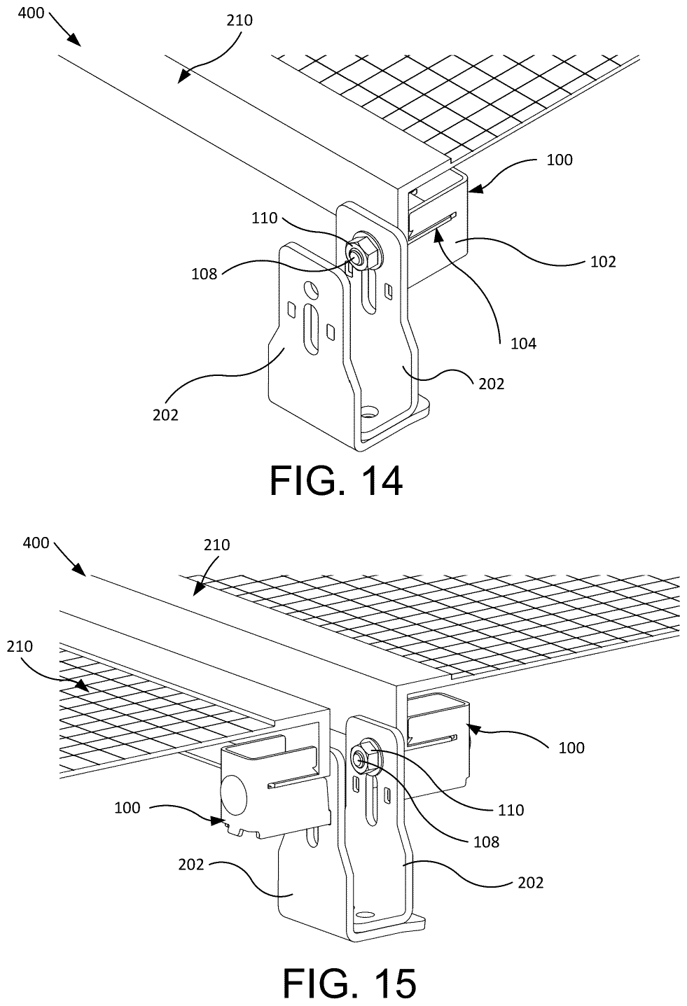

FIGS. 14-15 illustrate a system 400 for securing multiple solar panels 210. As shown in FIGS. 14-15, mounting brackets 202 are installed upon on another and each mounting bracket 202 secures to a solar panel 210 by using at least one mounting bracket 100. The system 400 optionally electrically bonds or grounds itself with the sharp barbs 106 protruding into the solar module 210 and to the upright solar roof mounting bracket 202 simultaneously. When adding additional rows of solar modules 210, the upright solar roof brackets 202 can be connected together, or overlapped, to form an electrical bond between solar module rows. The electrical grounding or bonding barbs 106 can help electrically bond the system. The barb 106 may further prevent the solar module 210 from sliding out of position during the install process.

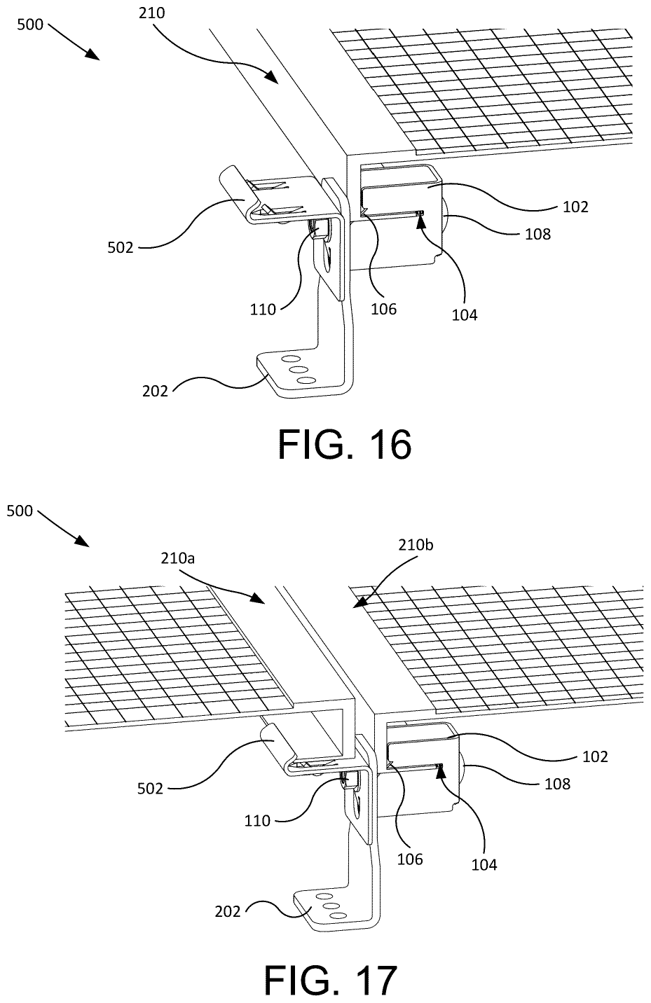

FIGS. 16-17 illustrate a system 500 for securing multiple solar panels 210. The system 500 includes at least one solar panel 210 secured by a mounting clamp 100 to a mounting bracket 202. The system 500 further includes a flange hook 502 which is attached to the mounting bracket 202. The flange hook 502 is secured to the solar panel's 210 lower flange, similar to the mounting clamp 100. In some examples the flange hook 502 is attached to mounting bracket 202 by a fastener. In alternative examples, the flange hook 502 is directly incorporated into the mounting bracket 202. In some examples, the flange hook 502 can speed up the install process as no bolts, or fasteners, are require to be attached to the solar module 210 lower flange at all. In some examples, a flange hook 502 can be fastened to most all existing L-foot and other upright style solar roof brackets which incorporate an open center slot hole in the vertical face. In some examples, the flange hook 502 can be fastened directly to all upright solar roof brackets 202 from most all solar industry manufactures, and the available open slot on most upright solar roof brackets 202 currently being used today can be utilized to fasten to directly, and also work well with an anti-rotation catch to engage into this generic open slot area.

In some examples, a system 500 of solar panels 210 comprises a combination of mounting clamps 100 and flange hooks 502 to secure solar panels to various mounting brackets 202 along the solar panel 210.

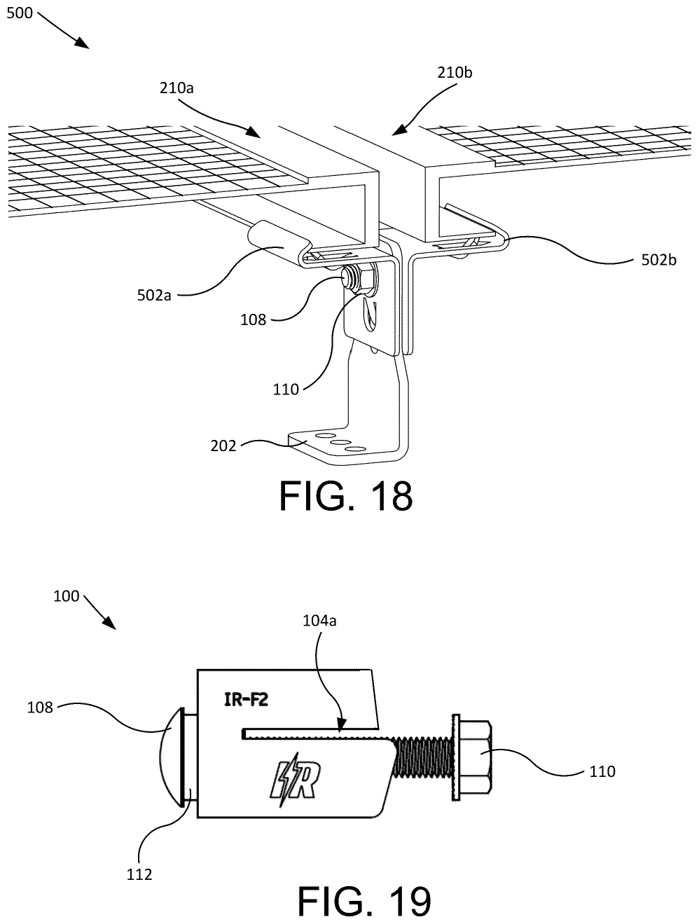

FIG. 18 illustrates a system 600 for securing a solar panel 210. The system 600 illustrates two solar panels 210a-b secured by corresponding flange hooks 502a-b and mounted on a mounting bracket 202.

A method of securing a structural component to a structural member by receiving a flange of a solar panel 210 in a receiving slot 104 of a body 102 of a mounting clamp 100, wherein the mounting clamp 100 includes the body 102, the at least one receiving slot 104 in the body 102 for receiving the flange of the solar panel 210, and a fastener attached to the body 102 for connecting the mounting clamp 100, the solar panel 210, and the structural member. Aligning the solar panel 210 to the structural member. Securing the fastener of the mounting clamp 100 to the structural member. Tightening the fastener of the mounting clamp 100 until the solar panel 210 is abutted to the structural member.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of” when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A mounting clamp for mounting a structural member to a solar panel, the mounting clamp comprising:
a body;
at least one receiving slot in the body for receiving a flange of a solar panel; and
a fastener attached to the body for connecting the mounting clamp, the solar panel, and the structural member.

2. The mounting clamp of claim 1, wherein the body is a u-shaped body.

3. The mounting clamp of claim 2, wherein the u-shaped body further comprises at least one barb that is at least partially formed by the at least one receiving slot, the at least one barb configured to contact a vertical component of the solar panel to at least partially secure the clamp fastener to the solar panel.

4. The mounting clamp of claim 3, wherein an upper portion of the slot comprises the at least one barb and a lower portion of the slot extends beyond the length of the at least one barb of the upper portion of the slot.

5. The mounting clamp of claim 1, wherein the fastener comprises a bolt protruding lengthwise through at least part of the body.

6. The mounting clamp of claim 1, wherein the body comprises threads receivable for a threaded fastener.

7. The mounting clamp of claim 1, wherein the flange of the solar panel is a lower return flange of the solar panel.

8. The mounting clamp of claim 1, wherein the fastener sandwiches the solar panel flange between the mounting clamp and the structural member.

9. A system comprising:
a structural member;
at least one solar panel; and
at least one mounting clamp for mounting the structural member to a solar panel,
the mounting clamp comprising:
a body;
at least one receiving slot in the body for receiving a flange of a solar panel; and
a fastener attached to the body for connecting the mounting clamp, the solar panel, and the structural member.

10. The system of claim 9, wherein the body of the mounting clamp is a u-shaped body.

11. The system of claim 10, wherein the u-shaped body further comprises at least one barb that is at least partially formed by the at least one receiving slot, the at least one barb configured to contact a vertical component of the solar panel to at least partially secure the clamp fastener to the solar panel.

12. The system of claim 11, wherein an upper portion of the slot comprises the at least one barb and a lower portion of the slot extends beyond the length of the at least one barb of the upper portion of the slot.

13. The system of claim 10, wherein the at least one barb grounds electrical components of the solar panel.

14. The system of claim 9, wherein the fastener comprises a bolt protruding lengthwise through at least part of the mounting clamp body and extends at least partially through at least one vertical component of the structural member.

15. The system of claim 9, wherein the body of the mounting clamp comprises threads receivable for a threaded fastener.

16. The system of claim 9, wherein the flange of the solar panel is a lower return flange of the solar panel.

17. The system of claim 9, wherein the structural member is a standoff bracket comprising at least one vertical member and at least one horizontal member for securing the system to an external surface.

18. The system of claim 9, wherein the structural member is a rack frame comprising at least one vertical leg for receiving the fastener of the mounting clamp.

19. The system of claim 9, wherein the at least one solar panel is secured by the mounting clamp to the structural member at a height which permits airflow beneath the at least one solar panel.

20. A method of securing a structural component to a structural member:
receiving a flange of a solar panel in a receiving slot of a body of a mounting clamp,
wherein the mounting clamp comprises:
the body;
the at least one receiving slot in the body for receiving the flange of the solar panel; and
a fastener attached to the body for connecting the mounting clamp, the solar panel, and the structural member;
aligning the solar panel to the structural member;
securing the fastener of the mounting clamp to the structural member; and
tightening the fastener of the mounting clamp until the solar panel is abutted to the structural member.
